(19) United States
(12) Patent Application Publication
(10) Pub. No.: US 2007/0299929 A1
(43) Pub. Date: Dec. 27, 2007

(54) CLIENT DEVICE INTERFACE FOR PORTABLE COMMUNICATION DEVICES

(76) Inventor: Stig S. NIELSEN, Laguna Hills, CA (US)

Correspondence Address: KYOCERA WIRELESS CORP., P.O. BOX 928289, SAN DIEGO, CA, 92192-8289, US

(21) Appl. No.: 11/426,899

(22) Filed: Jun. 27, 2006

(51) Int. Cl. G06F 15/16

(52) U.S. Cl. 709/217

(57) ABSTRACT

A client device interface system comprises a host processor and a switch. The host processor has a host bus interface and a plurality of general purpose input output (GPIO) ports, where each GPIO port is uniquely associated with a client device bus of a plurality of client devices buses. The host processor is configured to generate a control signal in accordance with an interrupt request signal received on an identified GPIO port of the plurality of GPIO ports to direct a switch to connect the host bus interface to an identified client device bus corresponding to the identified GPIO port.

### FIELD OF THE INVENTION

The invention relates in general to portable communication devices and more specifically to a client device interface for portable communication devices.

### BACKGROUND OF THE INVENTION

In order to expand the functionality of a portable communication device such a cellular phone or wireless PDA, the portable communication device is often designed to connect to one or more client devices. The client device such as a memory module or wireless communication module communicates with a host processor in the communication device through a communication bus. Connectors may be used to provide a standard bus interface for communicating with any of one of several types of client devices. Conventional portable communication devices, however, are limited in that the host processor must have a host bus interface for each client device.

Accordingly, there is a need for a client device interface for portable communication for connecting multiple client devices to a single host bus interface.

### SUMMARY OF THE INVENTION

A client device interface system comprises a host processor and a switch. The host processor has a host bus interface and a plurality of general purpose input output (GPIO) ports, where each GPIO port is uniquely associated with a client device bus of a plurality of client devices buses. The host processor is configured to generate a control signal in accordance with an interrupt request signal received on an identified GPIO port of the plurality of GPIO ports to direct a switch to connect the host bus interface to an identified client device bus corresponding to the identified GPIO port.

### BRIEF DESCRIPTION OF THE DRAWINGS

FIG. 1 is a block diagram of a communication bus interface system in accordance with an exemplary embodiment of the invention.

FIG. 2 is a block diagram in accordance with an exemplary implementation of the client bus interface system within a portable communication device where the client devices include an internal wireless module and removable memory devices.

FIG. 3 is a flow chart of an exemplary method for managing connections between multiple client buses and a single host bus.

### DETAILED DESCRIPTION

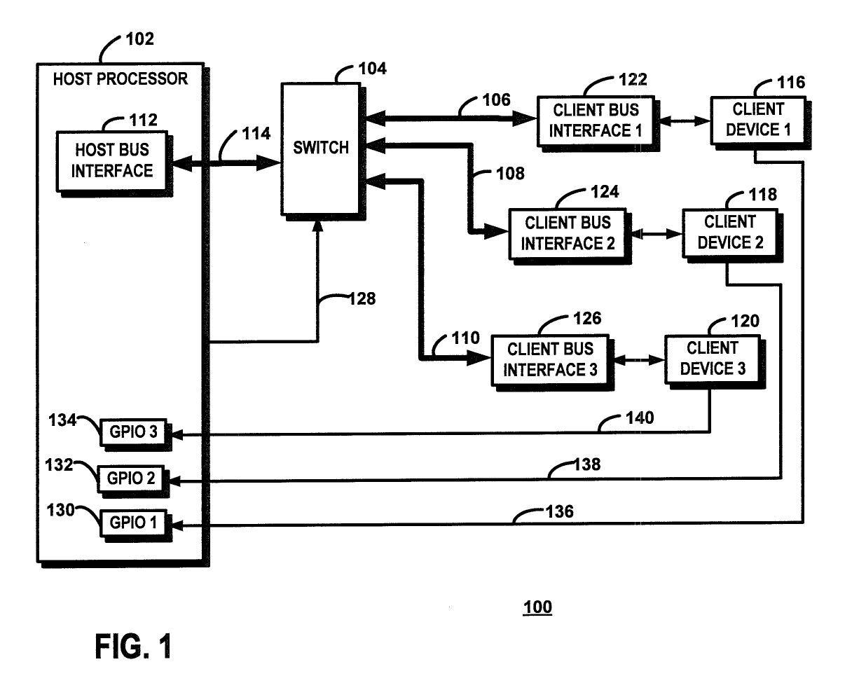

FIG. 1 is a block diagram of a communication bus interface system 100 in accordance with an exemplary embodiment of the invention. Although the communication bus interface system 100 may be implemented within any of numerous devices, systems and networks, the exemplary communication bus interface system is implemented for use with a portable communication device such as a cellular phone. The functions and operations of the blocks described in FIG. 1 may be implemented in any number of devices, circuits, or elements. Two or more of the functional blocks may be integrated in a single device and the functions described as performed in any single device may be implemented over several devices. For example, the switch host processor 102 and the switch 104 may be implemented within a single integrated circuit (IC) such as Application Specific IC (ASIC) in some circumstances.

As explained below, the communication bus interface system 100 allows multiple client buses 106, 108, 110 to be connected to a single host bus interface 112 of the host processor 102. The host bus interface 112 includes the necessary software and hardware for forming a communication interface that receives and/or transmits signals on multiple conductors that form the host bus 114. In the exemplary embodiment, the host bus 114 exchanges information in accordance with secure digital input/output (SDIO) protocols and includes a clock conductor (CLK) and a command conductor (CMD) and at least one data conductor (DATA). The client buses 106, 108, 110 are multiple conductor buses that exchange signals that corresponding to the signals of the host bus 114.

Client devices 116, 118, 120 are connected to the switch 104 through client bus interfaces 122, 124, 126 and the client buses 106, 108, 110. In the exemplary embodiment, each client device 116, 118, 120 is connected to a dedicated client bus interface 122, 124, 126 and client bus 106, 108, 110. The client bus interfaces 122, 124, 126 may include connectors that allow a removable client device such as memory card to be connected to the client bus when the client device is plugged into the connector. The client bus interfaces may also include hardwired connections between the client device and the client bus. For example, the client device may be a permanent circuit that is part of the portable communication device.

Each of the client devices 116, 118, 120 generates an interrupt request signal 136, 138, 140 indicating that the client device 116, 118, 120 will communicate over the bus. The interrupt request signals 1136, 138, 140 are received by the host processor 102 at a general purpose input output (GPIO) ports 130, 132, 134 that are uniquely associated with each client device 116, 118, 120. During operation when at least two client devices are connected to the switch 104 through two client buses, the switch 104 connects one of the client buses to the host bus in accordance with a control signal 128 generated by the host processor 102. The host processor 102 generates the control signal based on the states of the general purpose input output (GPIO) ports 130, 132, 134 to configure the switch 104 to connect the client bus corresponding to the client device that has provided an interrupt request signal 136, 138, 140. The host processor, therefore, detects an interrupt signal to identify one of the GPIO ports as the identified GPIO port and generates the control signal to configure the switch to connect the client device connected to the identified GPIO port.

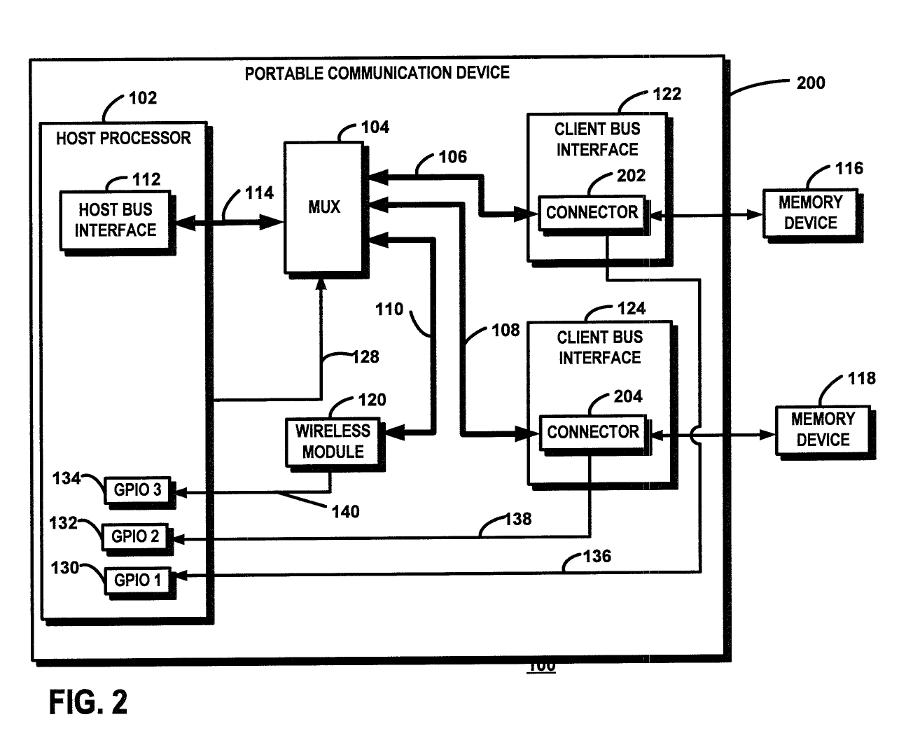

FIG. 2 is a block diagram of the exemplary client bus interface system 100 where the switch is a multiplexer and the client devices include a wireless module 120 and two memory modules 116, 118. FIG. 2, therefore, is an illustration in accordance with an exemplary implementation of the client bus interface system 100 within a portable communication device 200. The portable communication device 200 includes hardware, software, and firmware not shown in FIG. 2 for facilitating and performing the functions of the portable communication device 200. For example, the portable communication device 200 includes input and output devices such as keypads, displays, microphones and speakers. The functions and operations of the blocks described in FIG. 2 may be implemented in any number of devices, circuits, or elements. Two or more of the functional blocks may be integrated in a single device and the functions described as performed in any single device may be implemented over several devices.

The wireless module 120 is connected internally to the portable communication device 200. The wireless module includes a radio modem that operates in accordance with one or more radio protocols such as WiFi and other federal communication commission (FCC) 802.11 protocols.

The memory devices 116, 118 may be any type of memory devices that operate in accordance with a standard interface such as the SDIO interface standard. Examples of suitable memory devices include T-Flash plug-in memory modules. In the exemplary implementation described with reference to FIG. 2, the first client interface bus 122 and the second client interface bus 124 each include a connector 202, 204 that is configured to receive a client device such as memory device. An example of a suitable connector includes a nine pin SDIO connector that includes a card detection/Data I/O (CD/DAT3) pin, a command (CMD) pin, two ground (Vss) pins, a power supply (VDD) pin, a clock (CLK) pin, and three data I/O pins (DAT0, DAT1, DAT2).

An example of suitable switch includes a multiplexer (MUX) 104 such as the NC7SB3157 multiplexer available from Fairchild semiconductor as an integrated circuit. The MUX 104 connects one of the three client buses 106, 108, 110 to the host bus in accordance with the control signal generated by the host processor.

The first GPIO port 130 of the host processor is connected to the first memory device through the connector 202 and is configured to receive interrupt request signals 136 generated by the first memory device. The second GPIO port 132 of the host processor 102 is connected to the second memory device 118 through the connector 204 and is configured to receive interrupt request signals 138 generated by the second memory device 118. Another GPIO port 134 is connected to the wireless module 120. When one of the memory devices or the wireless module 120 generates an interrupt request signal 136, 138, 140, the processor detects the signal at the corresponding GPIO port and generates the control signal 128 connect the device that generated the signal to the host bus 114. The host processor 102 may invoke collision avoidance procedures or other communication management techniques to efficiently control the MUX 104.

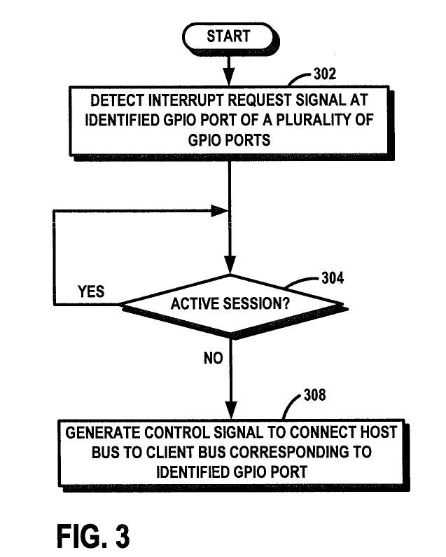

FIG. 3 is a flow chart of an exemplary method for managing connections between multiple client buses and a single host bus 114. Although the method may be performed in any combination of hardware, software, and/or firmware, the exemplary method is performed by executing code on the host processor 102 to control hardware including the switch 104.

At step 302, an interrupt request signal is detected at a GPIO port. The host processor 102 detects a signal such as logic high at a GPIO port to identify the GPIO port as the identified GPIO port from a plurality of GPIO ports 130, 132, 134. As explained above, each GPIO port is uniquely associated with a client device and a corresponding client bus.

At step 304, it is determined whether the host processor 102 is involved in an active session over one of the client buses 106, 108, 110. If there is an active session, the method returns the step 304 to continue monitoring the activity on the host bus 114. When there is no active session the method proceeds to step 306.

At step 306, host processor 102 generates a control signal 128 to connect the host bus 114 to the client bus corresponding to the identified GPIO port where the interrupt request signal was detected. The control signal 128 is transmitted provided to the switch 104. In respond to the control signal 128, the switch connects the host bus 114 to the client bus corresponding to the client device that generated the interrupt request signal.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

What is claimed is:

1. A client device interface system comprising:
a host processor having a host bus interface and a plurality of general purpose input output (GPIO) ports, each GPIO port uniquely associated with a client device bus of a plurality of client devices buses, the host processor configured to generate a control signal in accordance with an interrupt request signal received on an identified GPIO port of the plurality of GPIO ports; and
a switch configured to connect, in response to the control signal, the host bus interface to an identified client device bus corresponding to the identified GPIO port.

2. The client device interface system of claim 1, wherein the switch is a multiplexer.

3. The client device interface of claim 1, wherein the interrupt request signal is generated by an identified client device connected to the identified client device bus.

4. The client device interface system of claim 3, wherein the host processor is further configured to generate the control signal when the host bus is inactive.

5. The client device interface system of claim 3, wherein each of a plurality of client devices is connected to the switch through exactly one of the plurality of client device buses.

6. The client device interface system of claim 5, wherein the plurality of client devices comprises a memory device and a wireless module.

7. The client device interface system of claim 6, wherein the memory device is a removable memory device connected to the switch through a connector.

8. The client device interface system of claim 1, wherein the host bus operates in accordance with a secure digital input/output (SDIO) interface standard.

9. A method of managing connections with a host bus, the method comprising:
detecting an interrupt request signal at an identified general purpose input output (GPIO) port of a plurality of GPIO ports uniquely associated with a plurality of client device buses; and
generating a control signal to activate a switch to connect a host bus to an identified client bus corresponding to the identified GPIO port.

10. The method of claim 9, wherein the switch is a multiplexer.

11. The method of claim 9, wherein detecting comprises detecting the interrupt request signal generated by an identified client device connected to the identified client device bus.

12. The method of claim 11, further comprising determining if the host bus is active and generating the control signal only if the host bus is inactive.

13. The method of claim 11, wherein each of a plurality of client devices is connected to the switch through exactly one of the plurality of client device buses.

14. The method of claim 13, wherein the plurality of client devices comprises a memory device and a wireless module.

15. The method of claim 14, wherein memory device is a removable memory device connected to the switch through a connector.

16. The method of claim 9, wherein the host bus operates in accordance with a secure digital input/output (SDIO) interface standard.

17. A client device interface system comprising:
a host processor having a host bus interface and a plurality of general purpose input output (GPIO) ports, each GPIO port uniquely associated with a client device bus of a plurality of client devices buses, the host processor configured to generate a control signal in accordance with an interrupt request signal generated by an identified client device connected to the identified client device bus and received on an identified GPIO port of the plurality of GPIO ports; and
a multiplexer configured to connect, in response to the control signal, the host bus interface to an identified client device bus corresponding to the identified GPIO port.

18. The client device interface system of claim 17, wherein each of a plurality of client devices is connected to the switch through exactly one of the plurality of client device buses.

19. The client device interface system of claim 18, wherein the plurality of client devices comprises a memory device and a wireless module.

20. The client device interface system of claim 17, wherein the host bus operates in accordance with a secure digital input/output (SDIO) interface standard.
